(19) United States
(12) Patent Application Publication
(10) Pub. No.: US 2009/0032746 A1
(43) Pub. Date: Feb. 5, 2009

(54) Piezo-electric actuated valve

(75) Inventors: David Paul Smith, Reddick, IL (US); Wayne Walter Lark, Joliet, IL (US); Daniel Todd Mather, Lockport, IL (US); Larry Glenn Waterfield, Chillicothe, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/882,247

(22) Filed: Jul. 31, 2007

(51) Int. Cl. F16K 31/12

(52) U.S. Cl. 251/30.02

(57) ABSTRACT

A piezo-electric actuated valve having an inlet chamber, an outlet chamber, and an end chamber is disclosed. The valve also includes a main poppet disposed within the valve body. The main poppet is configured to be selectively movable between a flow blocking position substantially blocking a flow of pressurized fluid and a plurality of flow passing positions allowing fluid communication between the inlet and the outlet chambers. The valve also includes a pilot valve configured to be selectively movable between a first position substantially blocking a flow of pressurized fluid and a plurality of second positions allowing fluid communication between the end chamber and the one of the inlet and outlet chamber exposed to a pressurized fluid having a lower pressure. The valve further includes a piezo-electric actuator configured to be selectively movable between a de-energized position and an energized position to affect the pilot valve to selectively move to at least one the plurality of second positions. Movement of the pilot valve to one of the plurality of second positions affects the main poppet to selectively move to at least one of the plurality of flow passing positions.

### TECHNICAL FIELD

The present disclosure relates generally to valves, and more particularly, to a piezo-electric actuated valve.

### BACKGROUND

Hydraulic systems are often used to control the operation of hydraulic actuators associated with machines to accomplish a variety of tasks. These hydraulic systems typically include valves, arranged within hydraulic circuits, fluidly connected between the actuators and pumps. These valves may each be configured to control a flow rate and direction of pressurized fluid to or from respective chambers within the actuators. Often, the valves are solenoid actuated valves that can be selectively opened and closed by operating the solenoid, e.g., by selectively communicating an electrical signal thereto. Such solenoid actuated valves may each be independently operated with respect to the other valves in the hydraulic circuit increasing the operational flexibility of the hydraulic circuit.

U.S. Pat. No. 5,868,059 (“the '059 patent”) issued to Smith discloses a hydraulic circuit having four independent metering valves to control the flow of pressurized fluid to and from a hydraulic actuator. Each of the four independent metering valves includes a proportional electromagnetic device having an electrical coil and an armature to affect movement of an associated valve.

Although the hydraulic system of the '059 patent may provide independent metering of pressurized fluid to and from the hydraulic actuator, the proportional electromagnetic devices may require a significant amount of electrical energy to be energized and cause the associated valve to open or close. Because of the significant amount of electrical energy, the proportional electromagnetic devices associated with each valve must be physically connected to a source of electrical potential requiring substantial wiring to operate the valve. Additionally, the mechanical displacement of the armature of the proportional electromagnetic devices and thus movement of the associated valve element, i.e., the output, may be disproportionately small compared to the amount of electrical energy delivered to the proportional electromagnetic device, i.e., the input.

The present disclosure is directed to overcoming one or more of the shortcomings set forth above.

### SUMMARY OF THE INVENTION

In one aspect, the present disclosure is directed to a valve including a valve body having an inlet chamber, an outlet chamber, and an end chamber. The valve also includes a main poppet disposed within the valve body. The main poppet is configured to be selectively movable between a flow blocking position substantially blocking a flow of pressurized fluid and a plurality of flow passing positions allowing fluid communication between the inlet and the outlet chambers. The valve also includes a pilot valve configured to be selectively movable between a first position substantially blocking a flow of pressurized fluid and a plurality of second positions allowing fluid communication between the end chamber and the one of the inlet and outlet chamber exposed to a pressurized fluid having a lower pressure. The valve further includes a piezo-electric actuator configured to be selectively movable between a de-energized position and an energized position to affect the pilot valve to selectively move to at least one the plurality of second positions. Movement of the pilot valve to one of the plurality of second positions affects the main poppet to selectively move to at least one of the plurality of flow passing positions.

In another aspect, the present disclosure is directed to a valve including a valve body having an inlet chamber, an outlet chamber, and an end chamber. The valve also includes a main poppet disposed within the valve body. The main poppet is configured to be selectively movable between a flow blocking position substantially blocking a flow of pressurized fluid and a plurality of flow passing positions allowing fluid communication between inlet and the outlet chambers. The valve also includes a first pilot valve configured to be selectively movable between a first position substantially blocking a flow of pressurized fluid and a plurality of second positions allowing fluid communication between the outlet and end chambers. The valve further includes a first piezo-electric actuator configured to be selectively movable between a de-energized position and an energized position to affect the first pilot valve to selectively move to at least one of the plurality of second positions. Movement of the first pilot valve to one of the plurality of second positions affects the main poppet to selectively move to at least one of the flow passing positions.

### BRIEF DESCRIPTION OF THE DRAWINGS

FIG. 1 is a schematic illustration of an exemplary disclosed hydraulic system;

FIG. 2 is a diagrammatic illustration of an exemplary disclosed valve of the hydraulic system of FIG. 1;

FIG. 3 is a diagrammatic illustration of an exemplary disclosed valve of the hydraulic system of FIG. 1;

FIG. 4 is a diagrammatic illustration of an exemplary disclosed slot of the valve of either FIG. 2 or FIG. 3; and

FIG. 5 is a diagrammatic illustration of an exemplary disclosed slot of the valve of either FIG. 2 or FIG. 3.

### DETAILED DESCRIPTION

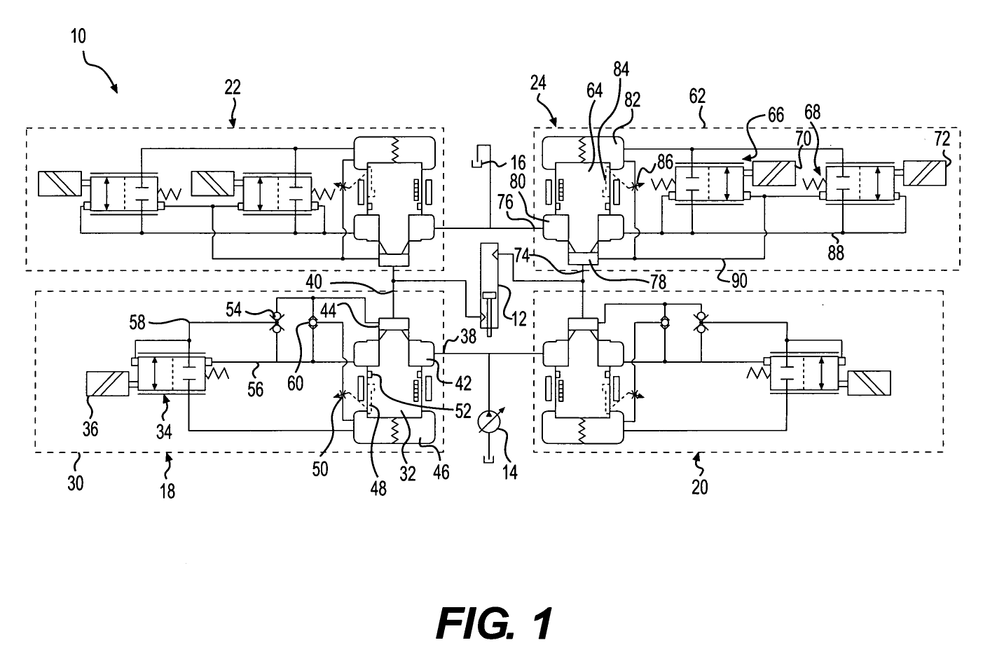

FIG. 1 illustrates a hydraulic system 10 that may include various components that cooperate to affect movement of hydraulic actuator 12. Hydraulic actuator 12 may be connected to various machine components, such as, for example, linkages (not shown), implements (not shown), and/or frames (not shown). Hydraulic system 10 may include a source 14 of pressurized fluid, a source of low pressure 16, a first supply valve 18, a first drain valve 22, a second supply valve 20, and a second drain valve 24. It is contemplated that hydraulic system 10 may include additional and/or different components such as, for example, pressure sensors, temperature sensors, position sensors, accumulators, check valves, and/or other components known in the art.

Hydraulic actuator 12 may include a piston-cylinder arrangement, a hydraulic motor, a variable displacement pump and/or any other hydraulic actuator having first and second fluid chambers therein. The first and second chambers may be selectively supplied with pressurized fluid to affect mechanical movement thereof, e.g., to displace a piston with a cylinder or rotate an output shaft. It is contemplated that hydraulic actuator 12 may be connected to and/or between any components of a machine to affect relative movement therebetween.

Source 14 may be configured to produce a flow of pressurized fluid and may include a pump such as, for example, a variable displacement pump, a fixed displacement pump, or any other source of pressurized fluid known in the art. Source 14 may be drivably connected to a power source (not shown) of a machine by, for example, a countershaft, a belt, an electrical circuit, and/or in any other suitable manner. Source 14 may be dedicated to supplying pressurized fluid only to hydraulic system 10, or alternately may supply pressurized fluid to additional hydraulic systems (not shown).

Low pressure source 16 may include, for example, a reservoir or a tank, configured to hold a supply of fluid. The fluid may include, for example, a dedicated hydraulic oil, an engine lubrication oil, a transmission lubrication oil, or any other fluid known in the art. One or more hydraulic systems may draw fluid from and return fluid to low pressure source 16. It is contemplated that hydraulic system 10 may be connected to multiple, separate low pressure sources.

First and second supply valves 18, 20 may be disposed between source 14 and hydraulic actuator 12 and may be configured to regulate a flow of pressurized fluid to the first and second chambers thereof. Specifically, first and second supply valves 18, 20 may each be configured to move between a plurality of flow passing positions at which pressurized fluid is allowed to flow between source 14 and the respective first and second chambers of hydraulic actuator 12 and a flow blocking position at which pressurized fluid flow is substantially blocked from flowing between source 14 and the respective first and second chambers of hydraulic actuator 12. First and second supply valves 18, 20 are substantially similar and, for clarification purposes, only first supply valve 18 will be described below. It is understood, however, that the description of first supply valve 18 is applicable to second supply valve 20.

First supply valve 18 may include a valve body 30 and a main poppet 32, a pilot valve 34, and a piezo-electric actuator 36. Main poppet 32 may be disposed within valve body 30 and include a generally cylindrical shape. Main poppet 32 may be movable to a plurality of flow passing positions allowing fluid communication between an inlet port 38 with an outlet port 40 and corresponding to the plurality of flow passing positions of first supply valve 18. Main poppet 32 may also be movable to a flow blocking position substantially blocking fluid communication between inlet port 38 and outlet port 40 corresponding to the flow blocking position of first supply valve 18. Inlet port 38 may be configured to fluidly connect source 14 with an inlet chamber 42 formed within valve body 30 having a generally annular shape and substantially surrounding main poppet 32. Outlet port 40 may be configured to fluidly connect the first chamber of hydraulic actuator 12 with an outlet chamber 44 formed within valve body 30 having a generally cylindrical shape and disposed at a first end of main poppet 32. Valve body 30 may also include an end chamber 46 having a generally cylindrical shape disposed at a second end of main poppet 32, opposite the first end. The pressurized fluid contained within each of inlet chamber 42, outlet chamber 44, and end chamber 46 may act on a respective exposed area of main poppet 32 to affect movement of main poppet 32 with respect to valve body 30. It is contemplated that the exposed area of end chamber 46 may be substantially equal to or greater than the sum of the areas of inlet chamber 42 and outlet chamber 44. It is contemplated that main poppet 32 may also include a spring bias (not referenced) configured to bias main poppet 32 toward the flow blocking position.

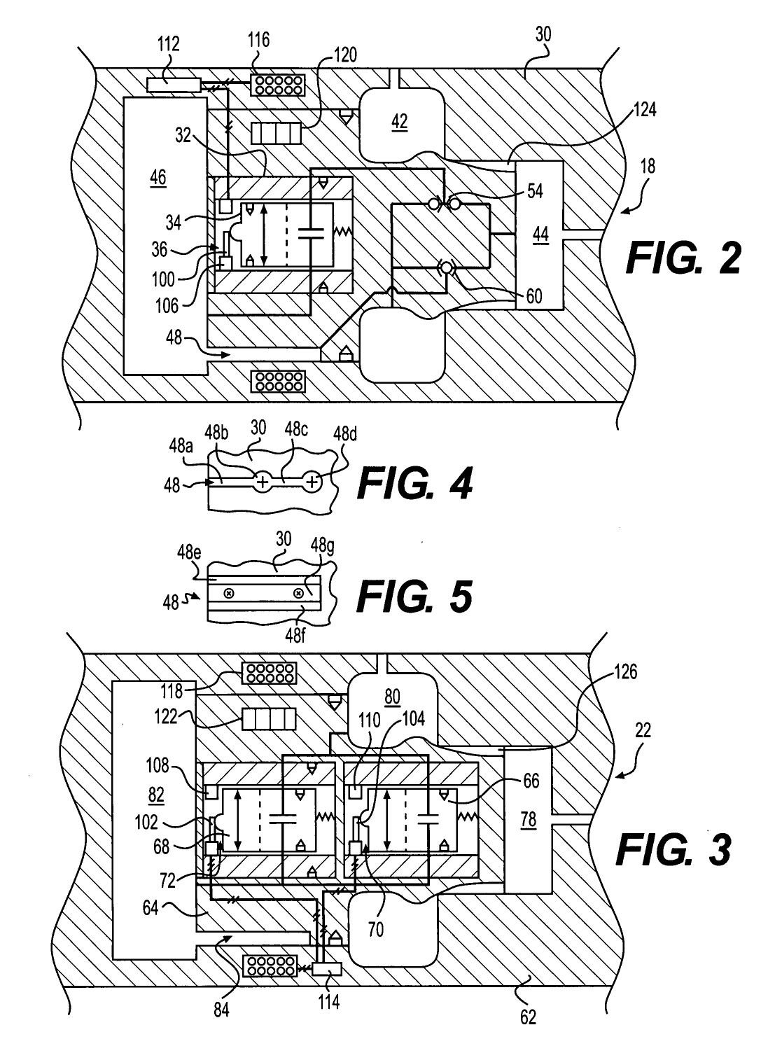

Main poppet 32 may also include a slot 48 formed on radial outer surface thereof and schematically shown in FIG. 1 as a variable orifice 50 via a dotted line. Specifically, slot 48 may include an axial slot extending from the second end of main poppet 32, e.g., the end exposed to end chamber 46, along main poppet 32 but not extending past a seal 52 fluidly sealing main poppet 32 with respect to valve body 30 and fluidly separating inlet chamber 42 and end chamber 46. As main poppet 32 moves from the flow blocking position to a maximum flow passing position, the amount of slot 48, e.g., the axial length thereof, that may be exposed to end chamber 46 may correspondingly increase and, thus, may operate as a variably increasing orifice. Slot 48 is further described below with reference to FIGS. 2-5. It is noted that orifice 50 is not an additional component within first supply valve 18 but is merely illustrated to show the variable flow characteristic of slot 48. It is further contemplated that seal 52 may establish main poppet 32 and, thus, first valve 18 as a zero-leak valve.

Pilot valve 34 may be movable between a plurality of flow passing positions allowing fluid communication between end chamber 46 and an inverse shuttle valve 54 and a flow blocking position substantially blocking fluid communication between end chamber 46 and inverse shuttle valve 54. Pilot valve 34 may be spring and pressurized fluid biased into the flow blocking position and may be movable to the plurality of flow passing positions upon actuation of piezo-electric actuator 36. Pilot valve 34 may be fluid biased on a first side thereof by pressurized fluid within passageway 56 fluidly connected to inlet chamber 42 and may be fluid biased on a second side thereof by pressurized fluid within passageway 58 fluidly connected to inverse shuttle valve 54. Pilot valve 34 may also be spring biased on the first end thereof toward the flow blocking position. It is contemplated that the effective areas of the pressurized fluid bias on the first and second sides of pilot valve 34 may be substantially equal and may be less than the full cross sectional area of the valve element thereof. It is also contemplated that pilot valve 34 may be disposed within main poppet 32 (as illustrated in FIG. 2). It is further contemplated that pilot valve 34 may include a seal disposed between the valve element and valve body thereof establishing pilot valve 34 as a zero-leak valve.

In addition to being fluidly connected with pilot valve 34, inverse shuttle valve 54 may be fluidly connected with inlet chamber 42 and outlet chamber 44. Inverse shuttle valve 54 may be configured to resolve the pressures of the pressurized fluid contained within inlet and outlet chambers 42, 44 and fluidly connect the respective chamber thereof having the lower pressure with passageway 58. For example, if the pressurized fluid contained within outlet chamber 44, e.g., from hydraulic actuator 12, has a pressure less than the pressure of pressurized fluid contained within inlet chamber 42, e.g., from source 14, inverse shuttle valve 54 may fluidly connect outlet chamber 44 with passageway 58.

Piezo-electric actuator 36 may include a piezo-electric element configured to be displaced in a first direction when energized and return to neutral when de-energized. Piezo-electric actuator 36 may be configured to affect movement of pilot valve 34 from the flow blocking position toward the plurality of flow passing positions when energized and may be configured to not affect movement of pilot valve 34 when de-energized. Piezo-electric actuator 36 will be further described with reference to FIG. 2 below.

First valve 18 may also include a ball resolver valve 60 fluidly connected with inlet chamber 42 and outlet chamber 44. Ball resolver valve 60 may be configured to resolve the pressures of pressurized fluid contained within inlet and outlet chambers 42, 44 and fluidly connect the respective chamber thereof having the higher pressure with slot 48. For example, if the pressurized fluid contained within inlet chamber 42 has a pressure greater than the pressure of pressurized fluid contained within outlet chamber 44, ball resolver valve 60 may fluidly connect inlet chamber 42 with slot 48. It is contemplated that first valve 18 may alternatively include a shuttle valve configured to resolve the pressure of pressurized fluid contained within inlet and outlet chambers 42, 44 and fluidly connect the respective chamber thereof having the higher pressure with slot 48

First and second drain valves 22, 24 may be disposed between hydraulic actuator 12 and tank 16 and may be configured to regulate a flow of pressurized fluid from the first and second chambers thereof to low pressure source 16. Specifically, first and second drain valves 22, 24 may each be configured to move between a plurality of flow passing positions at which pressurized fluid is allowed to flow from the first and second chambers, respectively, toward low pressure source 16 and a flow blocking position at which pressurized fluid may be substantially blocked from flowing from the first and second chambers, respectively. First and second drain valves 22, 24 are substantially similar and, for clarification purposes, only second valve 24 will be described below. It is understood, however, that the description of second drain valve 24 is applicable to first drain valve 22.

Second drain valve 24 may include a valve body 62 and a main poppet 64, first and second pilot valves 66, 68 and first and second piezo-electric actuators 70, 72. Main poppet 64 may be disposed within valve body 62 and include a generally cylindrical shape. Main poppet 64 may be movable to a plurality of flow passing positions allowing fluid communication between an inlet port 74 and an outlet port 76 and corresponding to the plurality of flow passing positions of second drain valve 24. Main poppet 64 may also be movable to a flow blocking position substantially blocking fluid communication between inlet port 74 and outlet port 76 and corresponding to the flow blocking position of second drain valve 24. Inlet port 72 may be configured to fluidly connect the second chamber of hydraulic actuator 12 with an inlet chamber 78 formed within valve body 62 having a generally cylindrical shape and disposed at a first end of main poppet 64. Outlet port 74 may be configured to fluidly connect low pressure source 16 with an outlet chamber 80 formed within valve body 30 having a generally annular shape and substantially surrounding main poppet 64. Valve body 62 may also include an end chamber 82 having a generally cylindrical shape and disposed at a second end of main poppet 64, opposite the first end. The pressurized fluid contained within each of inlet chamber 78, outlet chamber 80, and end chamber 82 may act on a respective exposed area of main poppet 64 to affect movement of main poppet 64 with respect to valve body 62. It is contemplated that the exposed area of end chamber 82 may be substantially equal to or greater than the sum of the exposed areas of inlet chamber 78 and outlet chamber 80. Main poppet 64 may also include a slot 84 formed on radial outer surface thereof and schematically shown in FIG. 1 as a variable orifice 86 via a dotted line, similar to schematically shown variable orifice 50. Slot 84 may be substantially similar to slot 48 of first supply valve 18 with respect to end chamber 82 and is further disclosed below with references to FIGS. 2-5.

First and second pilot valves 66, 68 may each be movable between a plurality of flow passing positions allowing fluid communication between end chamber 82 and outlet chamber 80 and a flow blocking position substantially blocking fluid communication between end chamber 82 and outlet chamber 80. First and second pilot valves 66, 68 may be spring and pressurized fluid biased into the flow blocking position and may be movable to the plurality of flow passing positions upon actuation of first and second piezo-electric actuators 70, 72, respectively. First and second pilot valves 66, 68 may be fluid biased on a first side thereof toward the flow blocking position by pressurized fluid within passageway 88 fluidly connected to outlet chamber 80. First and second pilot valves 66, 68 may be fluid biased on a second side thereof toward the plurality of flow passing positions by pressurized fluid within passageway 90 fluidly connected to inlet chamber 78. First and second pilot valves 66, 68 may also be spring biased on the first end thereof toward the flow blocking position. It is contemplated that the effective areas of the fluid bias on the respective first and second sides of first and second pilot valve 66, 68 may be substantially equal and may be less than the full cross sectional area of the respective valve element. It is also contemplated that first and second pilot valves 66, 68 may each be disposed within main poppet 64 (as illustrated in FIG. 3).

First and second piezo-electric actuators 70, 72 may each include a piezo-electric element configured to be displaced in a first direction when energized and return to neutral when de-energized. First and second piezo-electric actuators 70, 72 may each be configured to affect movement of first and second pilot valves 66, 68, respectively, from the flow blocking position toward the plurality of flow passing positions when energized and may be configured to not affect movement of first and second pilots valves 66, 68 when de-energized. First and second piezo-electric actuators 70, 72 will be further described with reference to FIG. 3 below.

Referring to FIGS. 2 and 3, each of piezo-electric actuators 36, 70, 72 may include a piezo-electric element 100, 102, 104 fixedly connected at a first end thereof to a mounting element 106, 108, 110 and having a second end in contact with an end of a respective pilot valve 34, 66, 68. As such, each of the piezo-electric elements 100, 102, 104 may radially extend from an inner surface of a respective pilot valve body, i.e., may be cantilevered. Upon being selectively energized, the second end of a piezo-electric element may axially deflect as a function of the strain generated therein and the first end being fixed. Deflection of the second end may affect movement of a respective pilot valve in contact therewith from a substantially flow blocking position to one of the plurality of flow passing positions. It is contemplated that a piezo-electric element as well as the spring and pressure bias acting on a respective one of pilot valves 34, 66, 68 may be sized such so as to significantly reduce the amount of force necessary to displace one of pilot valves 34, 66, 68. It is also contemplated that the shape and orientation of piezo-electric actuators 36, 70, 72 and, in particular, the shape and orientation of the piezo-electric elements 100, 102, 104 may include any size, shape, and/or piezo-electric material, may or may not be cantilevered, and may be configured to deflect via any desired method. Piezo-electric elements and materials are well known in the art and generally include a mechanical element in which strain may be generated upon the application of electrical stimulus, e.g., when a voltage or current potential is applied, and, as such, are not further described.

Piezo-electric actuators 36, 70, 72 may respectively be connected to an electrical potential 112, 114, e.g., voltage or current, to selectively energize piezo-electric elements 100, 102, 104. Electrical potentials 112, 114 may include a battery, a capacitor, and/or other source disposed within a respective one of main poppets 32, 64. Electrical potentials 112, 114 may be connected to a respective electromagnetic coils 116, 118 disposed within one of valve bodies 36, 62 that may at least partially surround a respective plurality of magnets 120, 122 disposed within a respective one of main poppets 32, 64. Additionally, the end of main poppets 32, 64 exposed to outlet chamber 44 and inlet chamber 78, respectively, may include vanes 124, 126 thereon. Vanes 124, 126 may be configured to respectively affect main poppets 32, 64 to rotate or spin within valve bodies 30, 62 as a function of a flow of pressurized fluid through first supply valve 18 or second drain valve 24 when a respective main poppet 32, 64 is in one of the plurality of flow passing positions. For example, vanes 124, 126 may include a plurality of helical or angled slots and/or grooves respectively disposed on a radial outer surface of the end of main poppet 32 exposed to outlet chamber 44 and a radial outer surface of the end of main poppet 64 exposed to inlet chamber 78. As such, plurality of magnets 120, 122 may rotate producing changing magnetic fields that may generate current within electromagnetic coils 116, 118 that, in turn, may respectively recharge electrical potentials 112, 114. It is contemplated that piezo-electric actuators 36, 70, 72, electrical potentials 112, 114, electromagnetic coils 116, 118, and plurality of magnets 120, 122 may respectively be electrically connected.

FIGS. 4 and 5 illustrate two exemplary slots which are described with reference to slot 48 for clarification purposes only. It is understood that the description of slot 48 is applicable to slot 84. As shown in FIG. 4, slot 48 may include a first groove portion 48a extending from the end of main poppet 32 to a first enlarged area portion 48b. Slot 48 may also include a second groove portion 48c extending from first enlarged area portion 48b to a second enlarged area portion 48d. First and second enlarged area portions 48b, 48d may include any shape and may be configured to provide a “soft-stop” for main poppet 32. For example, as main poppet 32 moves from the flow blocking position toward one of the plurality of flow passing positions, an increasing amount of slot 48 may be exposed to end chamber 46 which may allow a greater flow of pressurized fluid thereto as a function of the dimensions, e.g., area, of first groove portion 48a. As main poppet 32 continues to move away from the flow blocking position, first enlarged area portion 48b may be exposed to end chamber 46 allowing a step change increase in the amount of pressurized fluid allowed to flow into end chamber 46. As will be explained in more detail below, movement and position of main poppet 32 may be a function of the amount, e.g., area, of slot 48 exposed to end chamber 46. As shown in FIG. 5, slot 48 may alternatively include first and second grooves 48e, 48f separated by a key 48g fixedly connected to main poppet 32. It is contemplated that slot 48 may include an axial length and width of any dimension and may or may not include substantially constant axial length and/or width. It is also contemplated that the areas of first and second grooves 48e, 48f may be combined to establish the full area of slot 48. It is further contemplated that main poppets 32, 64 may include a plurality of slots which may or may not be equally spaced around a circumference thereof.

### INDUSTRIAL APPLICABILITY

The disclosed hydraulic system and supply and drain valves may be applicable to direct pressurized fluid to and from any hydraulic actuator and may reduce the amount of energy required to open and close the supply and drain valves. The operation of hydraulic system 10 is explained below with respect to an operation configured to direct pressurized fluid from source 14 toward hydraulic actuator via first supply valve 18 and direct pressurized fluid from hydraulic actuator toward low pressure source 16 via second drain valve 24 for exemplary purposes only. It should be understood that the description above and explanation below is applicable for any desired operation of hydraulic system 10 including first and second supply and drain valves 18, 20, 22, 24 being in any combination of flow blocking or flow passing positions.

Movement of hydraulic actuator 12 may be desired. Specifically, it may be desired to direct pressurized fluid toward one or both of the first and second chambers of hydraulic actuator 12, e.g., to affect an extension or retraction of a piston-cylinder arrangement, to affect a rotary output of a hydraulic motor, and/or to affect any desired output via any hydraulic actuator. Movement of hydraulic actuator 12 may affect a desired movement of a implement of a machine. For example, first supply valve 18 may be moved to one of the plurality of flow passing positions to direct pressurized fluid from source 14 toward a first chamber of hydraulic actuator 12 and second drain valve 24 may be moved to one of the plurality of flow passing positions to direct pressurized fluid from the second chamber of hydraulic actuator 12 toward low pressure source 16. As such, a pressure balance may be established between the first and second chambers of hydraulic actuator 12 which may affect movement thereof.

Referring to FIG. 1, first supply valve 18 may be in the flow blocking position as a function of a balance of forces resulting from the pressurized fluid respectively contained within inlet chamber 42, outlet chamber 44, and end chamber 46. Specifically, the area exposed to the pressurized fluid contained within end chamber 44 may be substantially equal to or greater than the sum of the areas exposed to the pressurized fluid contained within inlet chamber 42 and outlet chamber 44. Inlet chamber 42 may be fluidly connected to source 14 and may contain pressurized fluid therein having a first pressure. Outlet chamber 44 may be fluidly connected to a the first chamber of hydraulic actuator 12 and may contain a pressurized fluid therein having a second pressure. Ball resolver valve 60 may communicate the one of inlet chamber 42 and outlet chamber 44 having the higher pressure fluid with end chamber 46 via slot 48. The pressure of the pressurized fluid contained within end chamber 46 may be, for example, at a third pressure less than the higher pressure fluid of inlet and outlet chamber 42, 44 due to pressure drops through ball resolver valve 60 and slot 48 but may be greater than the lower pressure fluid of inlet and outlet chambers 42, 44. Because the exposed area of end chamber 46 may be substantially equal to or greater than the sum of the exposed areas of inlet and outlet chambers 42, 44 and because pilot valve 34 may be in the flow blocking position thereof, the resulting biasing force from the pressurized fluid contained within end chamber 46 acting on the exposed area thereof may bias main poppet 32 toward the flow blocking position. That is, the balance of forces on main poppet 32 resulting from the pressurized fluid contained within inlet, outlet, and end chambers 42, 44, 46 may bias main poppet 32 toward the flow blocking position. It is contemplated that the flow blocking position bias of main poppet 32 may be configured to provide any desired balance of forces, e.g., main poppet 32 may be in a substantially neutral balance wherein a slight balance of the forces may affect movement of main poppet 32 to one of the flow passing positions.

First supply valve 18 may be moved from the flow blocking position to one of the plurality of flow passing positions by energizing piezo-electric actuator 36. Energizing piezo-electric actuator 36 may displace piezo-electric element 100 which may bias pilot valve 24 against the spring and fluid bias toward one of the flow passing positions thereof. Pilot valve 34 in one of the flow passing positions may fluidly connect end chamber 46 with passageway 58, thus, fluidly connecting end chamber 46 with the one of inlet and outlet chambers 42, 44 containing the lower pressure fluid. As such, the pressurized fluid within end chamber 46 may be directed therefrom and toward the one of inlet and outlet chambers 42, 44 containing the lower pressure fluid. Because the pressure of the pressurized fluid contained within end chamber 46 may decrease as a result of end chamber 46 being fluidly connected with the low pressure fluid chamber, the resulting biasing force from the pressurized fluid contained within the one of inlet and outlet chambers 42, 44 containing the higher pressure pressurized fluid acting on the exposed area thereof may overcome the bias of the pressurized fluid contained within end chamber 46, and main poppet 32 may be biased toward one of the flow passing positions. Main poppet 32 may be biased to a position at which new balance of forces on main poppet 32 may be established, affecting main poppet 32 toward one of the flow passing positions. It is contemplated that the respective exposed areas of inlet, outlet, and end chambers 42, 44, 46 may be sized to achieve any desired balance of forces on main poppet 32. It is also contemplated that main poppet 32 may include a spring bias toward the flow blocking position thereof which may be accounted for in sizing the exposed areas of inlet, outlet, and end chambers 42, 44, 46.

The flow passing position of main poppet 32 may be a function of the amount pressurized fluid allowed to flow toward end chamber 46 via slot 48 and the amount of pressurized fluid allowed to flow from end chamber 46 via pilot valve 34. Specifically, as pilot valve 34 moves from the flow blocking position thereof, the amount of flow area therethrough may increase, thus increasing the flow area of pressurized fluid communicated from end chamber 46 toward passageway 58. Additionally, as main poppet 32 moves from the flow blocking position, the amount of slot 48 exposed to end chamber 46 may increase, thus increasing the flow area of pressurized fluid communicated from ball resolver valve 60 toward end chamber 46. The movement of main poppet 32 may correspond to a position wherein the amount of slot 48 exposed to end chamber 46, e.g., the slot area, may be substantially equal to the flow area of pilot valve 34. In an exemplary embodiment, slot 48 may be 0.5 mm×10 mm (corresponding to an area of 5 mm²) and the maximum flow passing area of pilot valve 34 may be 5 mm², such that upon movement of pilot valve 34 from the flow blocking position to the maximum flow passing position thereof, e.g., full actuation of piezo-electric actuator 36, main poppet valve may have a 10 mm stroke length.

For example, if the pressure of pressurized fluid from source 14 is greater than the pressure of pressurized fluid within the first chamber of hydraulic actuator 12, inlet chamber 42 may be fluidly connected to end chamber 46 via ball resolver valve 60 and slot 48. Upon movement of pilot valve 34 to one of the flow passing positions thereof, end chamber 46 may be fluidly connected to outlet chamber 44 via passageway 58 and inverse shuttle resolver 54, and main poppet 32 may be biased toward one of the flow passing positions allowing fluid communication between source 14 and the first chamber of hydraulic actuator 12. If pilot valve 34 is not actuated to one of the flow passing positions thereof, the balance of forces acting on main poppet 34 may maintain main poppet 34 in the flow blocking position even if the pressure of the pressurized fluid in the first chamber of hydraulic actuator 12 is greater than pressure of the pressurized fluid from source 14 because ball resolver valve may fluidly communicates the higher pressure pressurized fluid toward end chamber 46 via slot 48.

First supply valve 18 may also be configured as a pressure compensating valve to reduce the affect that pressure fluctuations from source 14 may have on hydraulic actuator 12 such as, for example, if source 14 is configured to supply pressurized fluid to additional hydraulic systems (not shown) at a pressure different than that desired to be supplied to hydraulic system 10. Specifically, when main poppet 32 is in one of the plurality of flow passing positions, pilot valve 34 may be in a corresponding flow passing position and piezo-electric actuator 36 may be energized. As the pressure of the pressurized fluid directed from source 14 varies, the pressure of pressurized fluid within passageway 56 may increase which may increase the fluid bias on a first end of pilot valve 34 toward the flow blocking position. This pressurized fluid bias may act against piezo-electric actuator 36 and may move pilot valve 34 toward the flow blocking position, thus reducing the flow area of pilot valve 34. As such, less pressurized fluid may be directed from end chamber 46 toward passageway 58 and the pressure of the pressurized fluid contained within end chamber 46 may correspondingly increase, affecting main poppet 32 to move toward the flow blocking position, reducing the flow area thereof and, thus, compensating for the increased pressure directed from source 14. It is contemplated that piezo-electric actuator 36 and, in particular, piezo-electric element 100 may be sized so as to be biased by any desired pressure change.

Second drain valve 24 may be moved from the flow blocking position toward one of the flow passing positions by energizing piezo-electric actuator 72. Energizing piezo-electric actuator 72 may displace piezo-electric element 102 which may bias pilot valve 68 against the spring and fluid bias toward one of the flow passing positions. Pilot valve 68 in a one of the flow passing positions may fluidly connect end chamber 82 with pressurized fluid passageway 88 and, with pilot valve 66 in the flow blocking position, the pressure of fluid contained within end chamber 82 may decrease and main poppet 64 may move to one of the plurality of flow passing positions substantially similar to main poppet 32. Movement of main poppet valve 64 to one of the flow passing positions may fluidly communicate the second chamber of hydraulic actuator 12 with low pressure source 16. Furthermore, second drain valve 24 may be pressure compensated for actuator load by pressure from the second chamber of actuator 12 directed through inlet port 74, inlet chamber 78, and passageway 90 to bias first pilot valve 66.

Second supply valve 24 may also be configured as a make-up valve to direct pressurized fluid from low pressure source 16 toward the second chamber of hydraulic actuator 12 when the pressure of pressurized fluid within the second chamber is less than a predetermined minimum pressure, e.g., lower than the pressure of pressurized fluid within low pressure source 16. Specifically, main poppet 64 may be in the flow blocking position as a function of being fluidly balanced by the pressurized fluid contained within inlet, outlet, and end chambers 78, 80, 82 and first and second pilot valves 66, 68 in the flow blocking positions. As the pressure of the pressurized fluid within the second chamber decreases, the pressure of the pressurized fluid contained within inlet chamber 78 may decrease and the pressure of pressurized fluid contained within end chamber 82 may correspondingly decrease because of the fluid communication between end chamber 82 and inlet chamber 78 via slot 84. If the pressure of pressurized fluid within the second chamber becomes less than the pressure within low pressure source 16, main poppet 64 may be fluidly biased toward one of the plurality of pressurized fluid passing positions as a function of the pressurized fluid contained within outlet chamber 80. That is, the balance of forces on main poppet 64 resulting from the pressurized fluid contained within inlet, outlet, and end chambers 78, 80, 82 may bias main poppet 64 toward one of the flow passing positions. It is contemplated that the areas of inlet, outlet, and end chambers 78, 80, 82 exposed to the pressurized fluid contained therein may be sized such that main poppet 64 may be configured to move toward one of flow passing positions when the pressure of the pressurized fluid within the second chamber is any desired level below the pressure of pressurized fluid within low pressure source 16. It is also contemplated that as the initially decreased pressure of pressurized fluid within the second chamber increases, the balance of forces on main poppet 64 may change and main poppet 64 may subsequently move toward the flow blocking position.

Second supply valve 24 may further be configured as a relief valve to direct pressurized fluid from the second chamber of hydraulic actuator 12 toward low pressure source 16 when the pressure within the second chamber is greater than a predetermined maximum pressure. Specifically, main poppet 64 may be in the flow blocking position as a function of being fluidly balanced by the pressurized fluid contained within inlet, outlet, and end chambers 78, 80, 82. As the pressure of the pressurized fluid within the second chamber increases, the pressure of the pressurized fluid contained within inlet chamber 78 may increase and the pressure of pressurized fluid contained within end chamber 82 may correspondingly increase via the pressurized fluid communication between end chamber 82 and inlet chamber 78 via slot 84. Additionally, first pilot valve 66 may be fluidly biased toward the flow blocking position at a first end thereof by pressurized fluid contained within outlet chamber 80 and may be biased toward the plurality of flow passing positions at a second end thereof by pressurized fluid contained within inlet chamber 78. As the pressure of the pressurized fluid within inlet chamber 78 increases, first pilot valve 66 may be biased toward one of the plurality of flow passing positions. That is, the balance of forces on first pilot valve 66 resulting from the pressurized fluid contained within inlet and outlet chambers 78, 80 may bias first pilot valve 66 toward one of the flow passing positions. Movement of first pilot valve 66 toward one of the plurality of flow passing positions may fluidly communicate outlet chamber 80 with end chamber 82, decreasing the pressure thereof and affecting main poppet 64 to move to one of the flow passing positions thereof in a similar manner as explained above.

It is contemplated that the areas corresponding to the pressurized fluid bias of first pilot valve 66 and the spring bias may be sized such that first pilot valve 66 may be configured to move toward one of flow passing positions when the pressure of the pressurized fluid within the second chamber is any desired pressure. It is also contemplated that as the initially increased pressure of pressurized fluid within the second chamber decreases, the balance of forces on first pilot valve 66 may change and first pilot valve 66 may subsequently move toward the flow blocking position which may correspondingly affect main poppet 64 to move toward the flow blocking position. It is further contemplated that first piezo-electric actuator 70 may, additionally or alternatively, be actuated to either modify or overcome the balance of forces on first pilot valve 66 thus modify the pressure of pressurized fluid within the second chamber of hydraulic actuator 12 that may bias pilot valve 66 toward one of the plurality of flow passing positions, i.e., affect the relief pressure.

Each of main poppets 32, 64 may be configured to generate electrical energy when in the plurality of flow passing positions. Specifically, pressurized fluid respectively flowing from inlet chambers 44, 78 toward outlet chambers 46, 80 may flow past vanes 124, 126 and may affect main poppets 32, 64 to respectively rotate or spin within valve bodies 30, 62. As such, plurality of magnets 120, 122 may rotate therewith and induce a current within electromagnetic coils 116, 118, respectively. The induced current may be directed toward electrical potentials 112, 114 for storage therein and may further be selectively directed toward piezo-electric actuator 36 and first and second piezo-electric actuators 70, 72, respectively. It is contemplated that first supply valve 18 and second drain valve 24 may further include a signal transmitter, such as, for example, a radio transmitter or other signal sending and receiving device, configured to receive control signals from a controller to selectively energize and de-energize piezo-electric actuator 36 and first and second piezo-electric actuators 70, 72. Signals from hydraulic system 10 may indicate various chamber pressures and various main poppet rotations or flows. All signals to and from each valve may be encoded such that signal information is passed within hydraulic system 10 to desired outside systems.

Because pilot valves 34, 66, 68 may be fluidly biased, a piezo-electric actuator may be sufficient to affect movement thereof. Additionally, because main poppets 32, 64 may be fluidly biased and include slots 48, 84, a relatively small flow of pressurized fluid through a respective pilot valve may provide a relatively large displacement of main poppets 32, 34. Furthermore, because piezo-electric actuators 36, 70, 72 may not require significant energy to energize, a battery or capacitor may provide a sufficient amount of energy to affect movement of a flow metering valve and affect movement of a hydraulic actuator. Moreover, because main poppets 32, 64 may include vanes 124, 126, magnets 120, 122, and coils 116, 118, first and second supply and drain valves 18, 20, 22, 24 may generate sufficient energy to charge the battery or capacitor and, thus, may eliminate relatively lengthy electrical connections between piezo-electric actuators 36, 70, 72 and a remote energy source. Furthermore, remote energy may be provided to charge the battery and/or capacitor wirelessly.

It will be apparent to those skilled in the art that various modifications and variations can be made to the disclosed hydraulic system and, in particular, to the disclosed piezo-electric actuated valve. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A valve comprising:
a valve body having an inlet chamber, an outlet chamber, and an end chamber;
a main poppet disposed within the valve body configured to be selectively movable between a flow blocking position substantially blocking a flow of pressurized fluid and a plurality of flow passing positions allowing fluid communication between the inlet and the outlet chambers;
a pilot valve configured to be selectively movable between a first position substantially blocking a flow of pressurized fluid and a plurality of second positions allowing fluid communication between the end chamber and the one of the inlet and outlet chamber exposed to a pressurized fluid having a lower pressure; and
a piezo-electric actuator configured to be selectively movable between a de-energized position and an energized position to affect the pilot valve to selectively move to at least one the plurality of second positions to affect the main poppet to selectively move to at least one of the plurality of flow passing positions.

2. The valve of claim 1, wherein the pilot valve is fluidly biased toward the first position by pressurized fluid communicated from the inlet chamber.

3. The valve of claim 1, wherein:
the inlet, the outlet, and the end chambers respectively include first, second, and third areas exposed to pressurized fluid; and
the third area is substantially equal to or greater than the sum of the first and second areas.

4. The valve of claim 1, further including a shuttle valve disposed between the inlet and the outlet chambers and configured to selectively communicate the one of the inlet and outlet chamber exposed to a pressurized fluid having a lower pressure toward the pilot valve.

5. The valve of claim 1, further including a ball resolver valve disposed between the inlet and the outlet chambers and configured to selectively communicate the one of the inlet and outlet chamber exposed to pressurized fluid having a higher pressure toward the end chamber.

6. The valve of claim 1, wherein the piezo-electric actuator is selectively energized as a function of selectively receiving a voltage from at least one of a battery or capacitor disposed within the valve body.

7. The valve of claim 1, wherein:
the main poppet includes a slot disposed on an outer surface thereof; and
the slot is configured to direct pressurized fluid from the one of the inlet and outlet chamber exposed to a pressurized fluid having a greater pressure toward the end chamber.

8. A valve comprising:
a valve body having an inlet chamber, an outlet chamber, and an end chamber;
a main poppet disposed within the valve body configured to be selectively movable between a flow blocking position substantially blocking a flow of pressurized fluid and a plurality of flow passing positions allowing fluid communication between the inlet and the outlet chambers; and
a first pilot valve configured to be selectively movable between a first position substantially blocking a flow of pressurized fluid and a plurality of second positions allowing fluid communication between the outlet and end chambers; and
a first piezo-electric actuator configured to be selectively movable between a de-energized position and an energized position to affect the first pilot valve to selectively move toward at least one of the plurality of second positions to affect the main poppet to selectively move to at least one of the flow passing positions.

9. The valve of claim 8, further including:
a second pilot valve configured to be selectively movable between a first position substantially blocking a flow of pressurized fluid and a plurality of second positions allowing fluid communication between the outlet and end chambers; and
a second piezo-electric actuator configured to be selectively movable between a de-energized position and an energized position to affect the second pilot valve to selectively move toward at least one of the plurality of second positions to affect the main poppet to selectively move to at least one of the plurality of flow passing positions.

10. The valve of claim 9, wherein the first piezo-electric actuator is selectively energized as a function of selectively receiving a voltage from at least one of a battery or capacitor disposed within the valve body.

11. The valve of claim 8, wherein:
the main poppet includes a slot disposed on an outer surface thereof; and
the slot if configured to direct pressurized fluid from the inlet chamber toward the end chamber.

12. The valve of claim 8, wherein the first pilot valve is fluidly biased toward the first position by pressurized fluid communicated from the outlet chamber and is fluidly biased toward the plurality of second positions by pressurized fluid communicated from the inlet chamber.

13. The valve of claim 8, wherein:
the inlet, the outlet, and the end chambers respectively include first, second, and third areas exposed to pressurized fluid; and
the third area is substantially equal to or greater than the sum of the first and second areas

14. The valve of claim 8, further including:
a plurality of magnets disposed within the main poppet;
an electromagnetic coil disposed within the valve body and surrounding at least a portion of the plurality of magnets; and
a plurality of vanes disposed on an end of the main poppet adjacent the inlet configured to effect the main poppet to rotate within the valve body.

15. A hydraulic system comprising:
a source of pressurized fluid;
a source of low pressure;
a hydraulic actuator;
a first valve having a first main poppet, a first pilot valve, and a first piezo-electric actuator configured to be selectively movable between a de-energized position and an energized position to affect the pilot valve to selectively move to at least one a plurality of flow passing positions to affect the main poppet to selectively move to at least one of a plurality of flow passing positions to fluidly connect the source and the hydraulic actuator; and
a second valve having a second main poppet, a second first pilot valve, and a second piezo-electric actuator configured to be selectively movable between a de-energized position and an energized position to affect the second pilot valve to selectively move toward at least one of a plurality of flow passing positions to affect the main poppet to selectively move to at least one of a plurality of flow passing positions to fluidly connect the hydraulic actuator and the source of low pressure.

16. The system of claim 15, wherein the first pilot valve is fluidly biased toward a flow blocking position by pressurized fluid communicated from the source.

17. The system of claim 15, wherein the second pilot valve is fluidly biased toward the plurality of flow passing positions by pressurized fluid communicated from the hydraulic actuator.

18. The system of claim 15, wherein the second valve further includes a third pilot valve and a third piezo-electric actuator configured to be selectively movable between a de-energized position and an energized position to affect the third pilot valve to selectively move toward at least one of a plurality of flow passing positions to affect the main poppet to selectively move to at least one of a plurality of flow passing positions to fluidly connect the hydraulic actuator and the source of low pressure.

19. The system of claim 18, wherein the third pilot valve is fluidly biased toward the plurality of flow passing positions by pressurized fluid communicated from the hydraulic actuator.

20. The system of claim 15, further including a plurality of magnets disposed within at least one of the first and second main poppets and an electromagnetic coil at least partially surrounding the plurality of magnets.
